(19) United States
(12) Patent Application Publication
(10) Pub. No.: US 2008/0137861 A1
(43) Pub. Date: Jun. 12, 2008

(54) Security Code Production Method and Methods of Using the Same, and Programmable Device Thereof

(75) Inventors: Erik Lindmo, Nesttun (NO); Petter Taugbol, Oslo (NO)

Correspondence Address: BIRCH STEWART KOLASCH & BIRCH, PO BOX 747, FALLS CHURCH, VA, 22040-0747, US

(73) Assignee: EnCap AS, Oslo (NO)

(21) Appl. No.: 11/795,015

(22) PCT Filed: Jan. 11, 2006
(86) PCT No.: PCT/NO06/00012

§ 371 Date: Nov. 9, 2007

(30) Foreign Application Priority Data
Jan. 11, 2005 (NO) 20050152

(51) Int. Cl. H04L 9/32; H04K 1/00; G06F 21/00; H04L 9/28

(52) U.S. Cl. 380/270; 380/28; 713/183; 713/185; 713/186

(57) ABSTRACT

A method of producing a security code by means of a programmable user device is described. The security code produced represents in itself both the user and the user device. In one embodiment, a service provider code representing a service provider by whom the user is registered with his/her user name forms an addition to the basis, on which the security code is calculated. The security code is useful for several security applications, such as for user authentication, and for local storage of information, as well as for signing and encryption/decryption of information to be exchanged between the user and a service provider, or vice versa.

### TECHNICAL FIELD

This invention relates to a method of producing a reproducable security code for user authentication, and for storing, signing and encryption/decryption of information by means of a programmable user device. The invention also relates to methods whereby the reproducable security code is utilized for various security purposes, and a corresponding programmable user device.

### BACKGROUND ART

In many situations where service providers offer services and transfer of information to the general public through electronic media, there is a need for a mechanism that provides for verified identification of the individual receiving the service or exchanging information with the service provider. Traditional authentication schemes employ user name and password pairs to authenticate users. This simple method provides, however, minimal security. To achieve a higher degree of security it is increasingly common to use so-called two-factor authentication. Such two-factor authentication is based on a “something you know” component (such as a password) and a “something you have” component; one example being a bank payment card (that you have) and the corresponding PIN (Personal Identification Number) code (that you know).

If a password is to be sent across an open telecommunications or computer network it may easily be captured by others. Therefore, it is desirable to permit the use of so-called one-time passwords (dynamic passwords) in stead of fixed (static) passwords (such as PIN codes). For this purpose, many banks, for example, are using card-like semiconductor devices (also called security tokens), which compute and display a one-time passcode (i.e. a time-varying number) on a small screen. By entering this number into a system when attempting to authenticate (login), the person doing so proves that he is in possession of the device. One example of such a semiconductor device is disclosed in U.S. Pat. No. 4,599,489. To increase the security, the semiconductor device itself sometimes is protected by a PIN code which is required to “open” the device. If so, first the correct PIN must be entered before the correct passcode numbers are displayed.

One problem with semiconductor devices of this kind is the substantial costs of their acquisition and distribution. Another problem is that a person who is a registered user of several services, such as banking services from various institutions via Internet, for example, the use of each requiring a separate semiconductor device, will have to keep and handle a plurality of different devices. It would, in deed, be beneficial to the public if a plurality of service providers could make use of one and the same semiconductor device as a common or generic “multi-code calculator” for a plurality of services.

On the other hand, arrangements are known that permit the implementation of security measures in electronic equipment of various kinds. For example, software may be stored in a communication terminal to be used for a secure communications service between a user and a service provider. The software needed may be stored as independent computer programs in the terminal memory. In one and the same terminal, applications may be stored that originate from different service providers for a variety of purposes.

A person who wishes to make use of a computer program for a service, such as a secure communications service, normally must register the program with the service provider before he is allowed to run that program on a computer for secure communication with that service provider. Once a registered user, he may run that program on any computer, usually by entering his user name and password, possibly a one-time passcode provided by the card-like semiconductor device, for example, mentioned above. This procedure makes sure that the user is in possession of the correct user name and password, or in the latter case, the correct card-like semiconductor device and corresponding PIN (if required).

To avoid the problems arising from having a plurality of card-like devices dedicated to respective ones of a plurality of service providers, the present invention seeks to make use of existing and future electronic information technology devices, typically those having a communication capacity, for the purpose of secure identity verification.

To achieve this, the inventors think that in stead of tying the identity of a user to a card-like semiconductor device especially designed and dedicated for one single purpose, it would be less costly and much more flexible to tie the identity of the user to a piece of equipment already in his possession or being acquired primarily for another, more general purpose than that of identification verification.

One intention of the invention is to avoid the need for any modification or supplementation of the hardware configuration of existing user devices to be used in the system according to the invention. Hence, electronic user devices apt for the prescribed use should as a minimum be programmable and comprise at least one data input interface, data processing means, data storage means, and data output capacities. In addition, for the device to operate according to the invention, the data storage means must include a readable tamper-proof storage in which an equipment identifier uniquely identifying the individual device is stored.

To ease the information exchange with selected service providers the equipment should preferably offer the user a suitable communications functionality. Such a communication capacity may be inherent to the device or be added as a functional extension.

Hence, in principle, a variety of electronic user devices may be used for the implementation of the invention. Mobile telephones (cell phones) compliant with the GSM (Global System for Mobile Communications) technology are, however, considered to be particularly well suited for the purpose of the invention, since every GSM mobile telephone already bears a unique equipment identifier stored in tamper resistant memory, viz. an International Mobile Equipment Identity (IMEI), which is a 15-digit code primarily being used to identify an individual GSM mobile telephone to a GSM network or operator. The presence of the IMEI code in a GSM mobile telephone usually is mandatory for the telephone to be operable in the GSM network. Hence, removing or altering the IMEI code would render the mobile telephone inoperable for its main purpose, namely telecommunication.

In this connection, examples of using IMEI codes for checking the compatibility of, and for controlling the right of use/activation of a mobile station, respectively, are known from U.S. Pat. Nos. 6,164,547 and 5,956,633. In addition, from US Patent Application Publ. No.s 2003/0236981 and 2004/0030906, respectively, it is known to use the IMEI code as a key for encryption of individual SMS (Short Message Service) messages, and for authentication of such messages through a digital signature computed with the IMEI code as a key.

WO 01/31840 A1 is a further example of prior art, describing how a first one-time password can be generated in a mobile station on the basis of a personal identification number (PIN), a subscriber identifier (typically IMSI in a GSM network), a device identifier (typically IMEI in a GSM network) and time (hence, a time-varying passcode), and then be used at an authentication server to enable a telecommunication connection between the mobile station and a computer system. To carry out the identification procedure the authentication server uses the subscriber identifier (IMSI) received from the mobile station for searching a database for the PIN code and device identifier (IMEI) associated with that subscriber, and when retrieved, all three entities are combined with time to produce a second one-time password for comparison with the first one.

This approach enables authentication to one computer system or service provider, but can not be used by more than one service provider without compromising security. If used by more than one service provider, the approach requires that the same identifiers (PIN, IMEI and IMSI) are distributed to each computer system, thereby compromising the security for all involved parties. Further, this approach can only be used for authentication, but not for other security functions like signing, encryption and secure distribution, nor can it be used for local encryption and access control of sensitive information, such as private PKI (Public Key Infrastructure) keys, for example, stored in a mobile telephone.

The prior art identifying process described in WO 01/31840 A1 is a process hidden to the user requiring no user interaction and it only represents a weak authentication of the user at the authentication instant. In addition, all the identifiers needed in the process, including the user PIN, are stored in the mobile station as well as in the computer system at the respective service providers. The approach is also limited to use of time as the only source of variable input to the one-time password calculation, which further limits the flexibility of the method.

In JP Patent Publication No. 2003 410949 a system and method are disclosed that generate unique codes and display the codes on the mobile terminal of a user, e.g. in the form of a picture. The user uses the picture and a “user secret” to authenticate itself to a service provider or computer system for accessing a service, like a cash withdrawal or a payment service. Aside from requiring additional user interaction, the method has a weakness in that the code can unintentionally be disclosed from the display. This method does not make use of mobile terminal identifiers for generating the user authentication data. The mobile terminal is used only as a communications terminal and not as a robust possession factor (something you have) in a two-factor authentication.

In the context of the present invention, the IMEI code of a mobile telephone would be utilized as the unique equipment identifier required for the mobile telephone to operate according to the invention.

Security mechanisms that can be used to access several different service providers are often based on so called public key algorithms. In a PKI system, the private keys need to be securely stored, whereas the public keys may be published in directories or certificates signed by a Trusted Third Party. To make sure that the private keys can be used only under the user's sole control, it is common to have the keys stored in a hardware key container, such as a smart-card or SIM (Subscriber Identity Module) Card. The main problem with such systems is the cost of the manufacture and distribution of the hardware. The present invention is offering a much cheaper solution to this need for a tamper-resistant, user controlled key container.

### DISCLOSURE OF INVENTION

One aspect of the present invention relates to a method of producing a reproducable security code for user authentication, and for storing, signing and encryption/decryption of information by means of a programmable user device comprising at least one data input interface, data processing means and data storage means including a readable tamper-proof storage in which an equipment identifier uniquely identifying the user device is prestored,

the method comprising the steps of:
inputting via said data input interface a user personal code into the user device,
fetching the equipment identifier from the data storage means of the user device,
calculating internal to the user device a security code based on a combination of at least said equipment identifier and said user personal code, and
outputting the calculated security code,
   the security code thus calculated in itself representing both the user and the user device.

The method of the invention generates data for two-factor user identification without the need to register, or store, the user personal code in any way.

In a preferred embodiment the method according to the invention further comprises the steps of, prior to the calculation internal to the user device of a security code:
inputting to the user device a service provider code representing a service provider by whom the user is registered with his/her user name,
calculating internal to the user device a security code based on a combination of the equipment identifier, the user personal code and said service provider code, and
outputting the calculated security code,
   the thus calculated security code in itself representing the user and the user device to one specific service provider.

By inputting a service provider code to the calculation of the security code, different security codes can be produced for each service provider, without the need of changing any of the other identifiers (user personal code and equipment identifier). The method of the invention enables a user to use the same device for two-factor user identification to more than one service provider without sharing sensitive data between service providers.

A special aspect of the invention relates to a method of authenticating the user of a user device, the user being registered in a customer file at a service provider with his/her user name and an associated security code obtained by a method according to the invention, the method comprising the steps of:
indicating a user name to the service provider,
at the service provider searching in the customer file to find the user name indicated, and if present in the file, returning a challenge to the user,
inputting to the user device a user personal code and fetching from the data storage means of the user device the equipment identifier of the user device,
calculating internal to the user device said security code,
inputting to the user device a variable received from the service provider as said challenge and by using a cryptographic algorithm calculating internal to the user device a one-time password based on said security code and said variable,
indicating the calculated one-time password to the service provider,
at the service provider retrieving from the customer file the security code corresponding to the user name indicated by the user,
by using the same cryptographic algorithm as the user device calculating at the service provider a one-time password based on the security code retrieved from the customer file and the same variable as that returned to the user and used by the user device,
at the service provider comparing the one-time password just calculated with that received from the user, and
   if the one-time passwords are identical, the authentication result is positive, confirming that the user identified by user name is in possession of the user device and of a corresponding user personal code, otherwise, the authentication result is negative.

Another aspect of the invention relates to a method of securely storing information on a programmable user device comprising at least one data input interface, data processing means and data storage means including a readable tamper-proof storage in which an equipment identifier uniquely identifying the user device is prestored, the method comprising the steps of encrypting the information prior to storage and decrypting the information upon retrieval of the stored, encrypted information, whereby:
the step of encrypting the information comprises encrypting the information to be stored by using a security code as encryption key, and
the step of decrypting the information comprises retrieving the stored, encrypted information by using the same security code as decryption key,
   said security code being produced by the steps of:
inputting via said data input interface a user personal code into the user device,
fetching the equipment identifier from the data storage means of the user device,
calculating internal to the user device a security code based on a combination of at least said equipment identifier and said user personal code, and
outputting the calculated security code for the encryption/decryption steps, respectively.

Still another aspect of the invention relates to a method of signing an information element to be exchanged between the user of a user device and a service provider, the user being registered in a customer file at the service provider with his/her user name and an associated security code obtained by a method according to the invention,

the method comprising the steps of:
transferring from the service provider to the user device the information element to be signed by the user, if the information element is not present at the user device,
inputting to the user device a user personal code and fetching from the data storage means of the user device the equipment identifier of the user device,
calculating internal to the user device said security code,
by using a cryptographic algorithm, calculating internal to the user device a “signature” based on said security code and the information element to be signed and transferred to the service provider,
transferring the user name and the “signature” to the service provider, and if the information element to be signed by the user is not present at the service provider, also transferring the information element to the service provider,
at the service provider retrieving from the customer file the security code corresponding to the user name received from the user,
by using the same cryptographic algorithm as the user device, calculating at the service provider a “signature” based on the security code retrieved from the customer file and the information element,
at the service provider comparing the “signature” just calculated with that received from the user, and
   if the “signatures” are identical, confirming that the user on the user device has intentionally signed the information element and that the information element has not been modified, otherwise, the signing result is negative.

In a special embodiment the “signature” may comprise a digital or electronic signature, or a message authentication code (MAC).

Yet another aspect of the invention relates to a method of securing an information element to be transferred from the user of a user device to a service provider, the user being registered in a customer file at a service provider with his/her user name and an associated security code obtained by a method according to the invention,

the method comprising the steps of:
inputting to the user device a user personal code and fetching from the data storage means of the user device the equipment identifier of the user device,
calculating internal to the user device said security code,
by using a cryptographic algorithm and said security code as encryption key, encrypting internal to the user device the information element to be transferred to the service provider,
transferring the user name and the encrypted information element to the service provider,
at the service provider retrieving from the customer file the security code corresponding to the user name received from the user, and
by using the same cryptographic algorithm as the user device, decrypting at the service provider the encrypted information element using the security code retrieved from the customer file as decryption key.

A further aspect of the invention relates to a method of securing an information element to be transferred from a service provider to the user of a user device, the user being registered in a customer file at a service provider with his/her user name and an associated security code obtained by a method according to the invention,

the method comprising the steps of:
at the service provider retrieving from the customer file the security code of the user to whom the information element is to be transferred,
by using a cryptographic algorithm and said security code as encryption key, encrypting said information element,
transferring the encrypted information element to the user,
upon receipt in the user device of said encrypted information element, inputting to the user device a user personal code and fetching from the data storage means of the user device the equipment identifier of the user device,
calculating internal to the user device said security code, and
by using the same cryptographic algorithm as the service provider, decrypting in the user device the encrypted information element using the security code just calculated as decryption key.

This method of securing information elements to be transferred from a service provider may be useful for sending messages, and for keeping information secret to others, as well as for sending digital content not to be copied (such as electronic tickets, or other digital content to be protected from illegal copying, music, video, software, etc.).

The invention also relates to a programmable user device comprising at least one data input interface, data processing means, data storage means including a readable tamper-proof storage in which an equipment identifier uniquely identifying the user device is prestored, the programmable user device being programmed to run a process according to any of the methods of the invention.

Preferably, the equipment identifier of the user device is a product serial number embedded in the device prior to delivery to a user, and in the case of a mobile telephone (cell phone), the equipment identifier may be an international mobile equipment identity (the IMEI code in the case of a GSM phone).

In general, the invention may allow a user device to serve as a common or generic “multi-code calculator” for a plurality of services from a plurality of service providers.

### BRIEF DESCRIPTION OF DRAWINGS

Further features of the user device and the method of producing a security code according to the present invention will appear from the following description of examples of embodiments thereof given by reference to the accompanying drawings, on which:

FIG. 1 is a schematic block diagram illustrating the basic components of a user device according to the invention,

FIG. 2 is a schematic flow chart illustrating a process of producing a security code representative of a user of a user device and of the device itself,

FIG. 3 is a schematic flow chart illustrating a process of securely storing information locally,

FIG. 4 is a schematic flow chart illustrating a process of using the information securely stored by the process of FIG. 3.

FIG. 5 is a schematic flow chart illustrating a process of distributing from a service provider information encrypted by a user's public key,

FIG. 6 is a schematic flow chart illustrating a process of distributing from a service provider information encrypted by a user's security code,

FIG. 7 is a schematic flow chart illustrating a process of authenticating a user in accordance with one embodiment of the invention, and

FIG. 8 is a schematic flow chart illustrating a process of initial user registration at a service provider.

### DESCRIPTION OF PREFERRED EMBODIMENTS

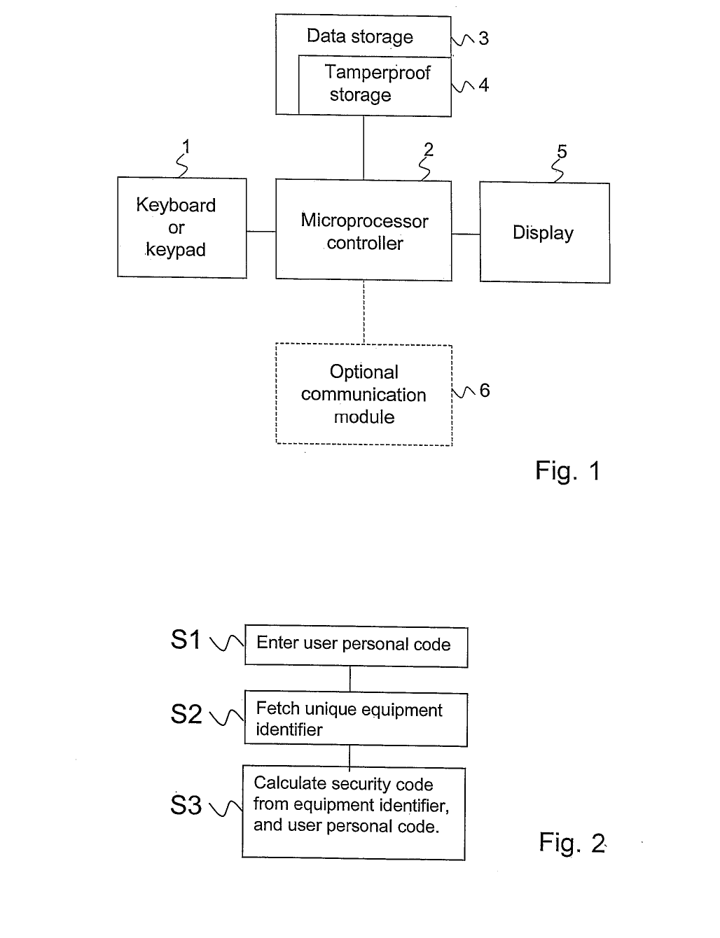

Referring to FIG. 1, a user device according to the invention comprises at least one data input interface, such as a numeric keypad, full keyboard 1, or other interface means, data processing means, such as a microprocessor controller 2, and data storage means 3, such as a RAM, ROM and/or cache memory, and including a readable tamper-proof storage 4, preferably a ROM, in which an equipment identifier uniquely identifying the device is stored, and data output capacities, such as a display window 5, computer monitor, and the like, and optionally, for some of the embodiments of the invention, a communications module 6 for unilateral or bilateral communication with external equipment, such as standard computer peripherals, computer networks, possibly including transceiver means for any kind of private or public telecom services.

The user device of the invention is programmable, i.e. it is capable of executing computer programs and applications read into its microprocessor's memory. To implement some embodiments of the invention the user device should also be capable of exchanging information with a service provider, by whom the user is registered as a customer or subscriber. Therefore, mobile telephones (cell phones) compliant with the GSM technology are considered to be particularly suitable for the purpose of the invention. It is, however, envisaged that other personal pieces of electronic equipment, such as portable computers (Laptops) and handheld information devices (PDA—Personal Digital Assistant), or indeed, stationary personal computers (PCs), and future mobile telephones, of course, may also be used when provided with an appropriate Equipment Identity (EI) in a manner similar to the GSM mobile telephones. Future pocket calculators or special purpose generic password generators may also be envisioned.

### The Security Code Calculation Software

The software needed for the calculation of the security code may be permanently stored in the user device of the invention. It may, for example, be implemented in the device at the time of manufacture. To permit the use of an already existing device of the appropriate kind as indicated above, a special application may be supplied to the device at any instant in time via any type of data supply media, such as a floppy disk, optical compact disk (CD-ROM) and plug-in data storage means (memory stick or card). In cases where the device is furnished with a communications capacity, the application may be downloaded from a software vendor via a communications network of the device, to the device for direct execution and/or storage for later utilization.

According to the invention the security code calculation software is a general computer program containing no secrets at all. The program or application may be open to the public for utilization on any suitable user device. In principle, the application may be identical from one user device to the next, except for computer related differences due to the use of different operating systems, programming languages, compilators, and the like.

This feature of, in principle, free distribution of the security code calculation software, and the possibility of copying the software from one device to another without compromising security, is a major advantage of the present invention, especially compared to security arrangements requiring the presence of secrets in the user software itself.

The calculation carried out by the security code software is typically based on the use of one-way encryption algorithms (e.g. a hashing algorithm) to produce the security code and two-way encryption algorithms to encrypt/decrypt information elements, but encryption algorithms of various other kinds may be used. The encryption method used is not decisive to the implementation of the invention. The security code should, however, be sufficiently unique and it should not be possible to derive its input data elements from the code itself (i.e. one-way encryption). Another important feature of the security code calculation software is that it is designed to read the equipment identifier uniquely identifying the device in question each and every time a security code is to be used and that the calculated security code never is stored in the device.

### Security Code Calculation

Referring to FIG. 2, in one embodiment, the method according to the invention, of producing a security code by means of a programmable user device (see FIG. 1) and the user software just described, comprises three main steps:
the user holding the device enters his/her user personal code into the device via a device data input interface (step S1),
the device fetches the equipment identifier from its own data storage means 4 (step S2), and
based on a combination of the equipment identifier fetched and the user personal code entered, the user device calculates internal to itself, a security code (step S3).

The security code thus obtained is based on two factors. Hence, regarded as a two-factor authentication scheme, the user personal code would constitute the “something you know” component while the equipment identifier is the “something you have” component. The security code represents a unique identification of the user and the user's device, but the original input identifiers (the user personal code and the equipment identifier) can not be re-calculated from the security code. The method according to the invention prevents the input identifiers from being exposed to any other party, and is also a method where there is no need for storing the user personal code in any way.

In principle, the user may freely select any suitable personal code to be entered for the production of a security code. The personal code may, of course, be a different one for different purposes. In the present case the security code is representative of both the user and the user device. The code may now be output via the data output capacities of the device, such as being displayed in the display window 5, or through the communications module 6 for sending to some external local or remote equipment, such as to communication equipment located at the site of a service provider.

Although not shown in FIG. 2, the calculation internal to the user device of a security code may alternatively, when appropriate in embodiments of the invention, be based on a combination of three factors. In addition to the two factors mentioned above, i.e. the equipment identifier and user personal code, a service provider code chosen by the service provider or by the user him/herself to designate a service provider, may be included in the calculation of the security code. Such a “three-factor” security code will in itself represent the user and the user device to the service provider, or a certain service offered by the respective service provider. Such service provider codes may, of course, be stored in the data storage 3 means of the user device for later use.

As an alternative to introducing the service provider code as a separate third code, some kind of indication of a specific service provider may be incorporated into the user personal code such that it becomes a two-part code, and there will be one different security code for each service provider.

The capability of the method of the invention of producing specific, or different, security codes for each service provider enables the user to use the same device for security services at more than one service provider without compromising security. No service providers need to share the same security code, and no service provider is able to recalculate the input identifiers.

With the development of biometric coding techniques the possibility is also envisaged that biometric data may be part of the security code according to the invention. Hence, biometric data representative of a user may constitute the user personal code alone or as an integral part thereof, thus moving from a “something you have” to a “something you are” situation. In such a case the user device needs to be furnished with or be connected to, appropriate input means to permit biometric particulars to be scanned from the user's attributes and supplied to the user device.

Typically each of the user personal code and the service provider code may comprise a sequence of alphabetic and/or numeric characters which is easy to remember and which, in the process, is converted into a sequence of binary coded data. The user and service provider codes may also, alone or in combination with other pieces of information, comprise a piece of information that is already converted into a sequence of binary coded data. Biometric data representative of a user is an example of such precoded binary data.

In any case the calculation of the security code may comprise a simple arithmetic operation, or a complex cryographic operation, or use of other kinds of enciphering techniques. The operation should, however, be such that none of the input data elements to the calculation are derivable from the code and/or from the knowledge of some of the input elements.

### Encryption/Decryption of Information

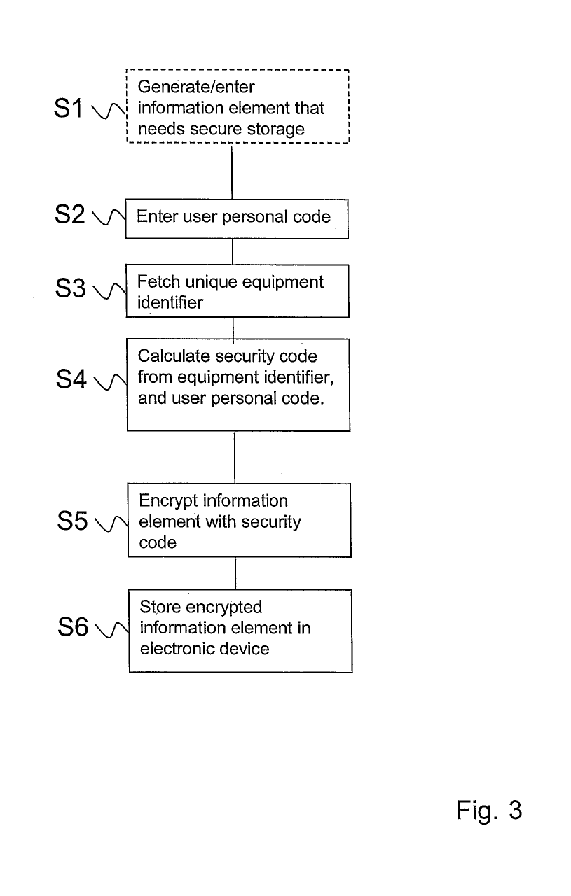

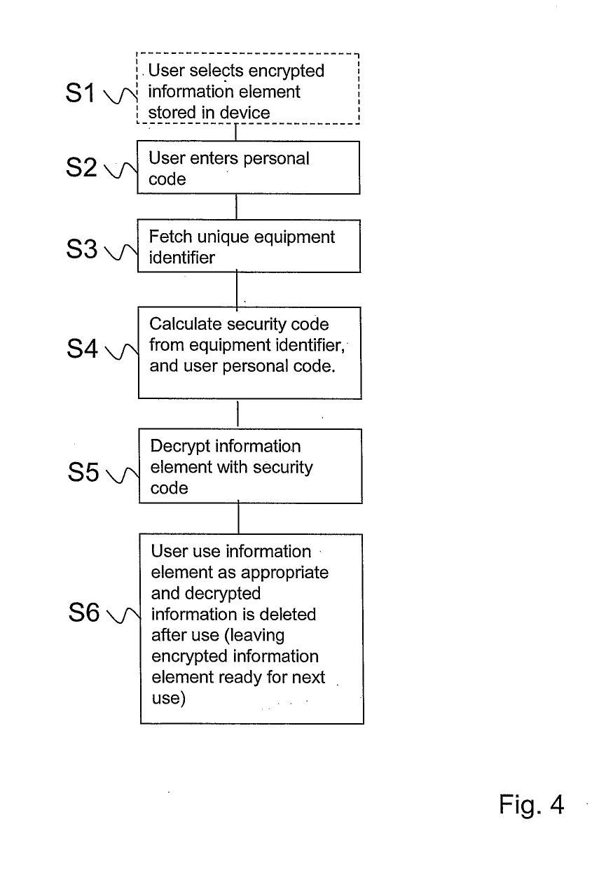

Referring now to FIG. 3, the security code of the invention may be used when storing elements of information on the user device, the information being encrypted prior to storage by using the security code as encryption key. The process may typically include the following steps:
the user specifies or starts by means of the keyboard 1, for example, a process or computer program that generates an information element that needs to be stored securely (e.g. a private key in a PKI (Public Key Infrastructure) system) (step S1),
the user enters a user personal code into the device, typically via the keyboard 1 (step S2),
the device fetches the equipment identifier from its own data storage means 4 and calculates internal to itself, a security code (steps S3 and S4), and
by using the security code as encryption key the device encrypts the information element and stores the encrypted information in the data storage means 3 of the device (steps S5 and S6).

If the user chooses to use different personal codes for different purposes, he/she may choose one specific code, for example, for the purpose of secure storage locally of information elements.

In the example shown a “two-factor” security code is produced but a “three-factor” security code may equally well be used, particularly when the information element to be securely stored relates to a service provider.

Later, within the user device, information elements thus being encrypted prior to storage on the device, may be retrieved and decrypted prior to use by using the security code as decryption key. Such a process may, as illustrated in FIG. 4, comprise the following steps:
the user selects by means of the keyboard 1, for example, or by other means specifies one or more information elements securely stored on the device (step S1),
the user enters into the device, typically via the keyboard 1 (step S2), the personal code used when storing the information element(s) concerned,
the device fetches the equipment identifier from its own data storage means 4 and calculates internal to itself, a security code (steps S3 and S4), and
by using the security code as decryption key the devices decrypts the information element(s) and the user is permitted to read and/or use the decrypted information as appropriate (steps S5 and S6).

In a preferred implementation, for security reasons the decrypted information element is always deleted after being used, leaving only encrypted information in the data storage means 3 of the device.

### The Security Code Used for Secure Communication

In a preferred embodiment the user device is furnished with a communications functionality permitting unilateral and/or bilateral data communication with a service provider through a wired or wireless communications network.

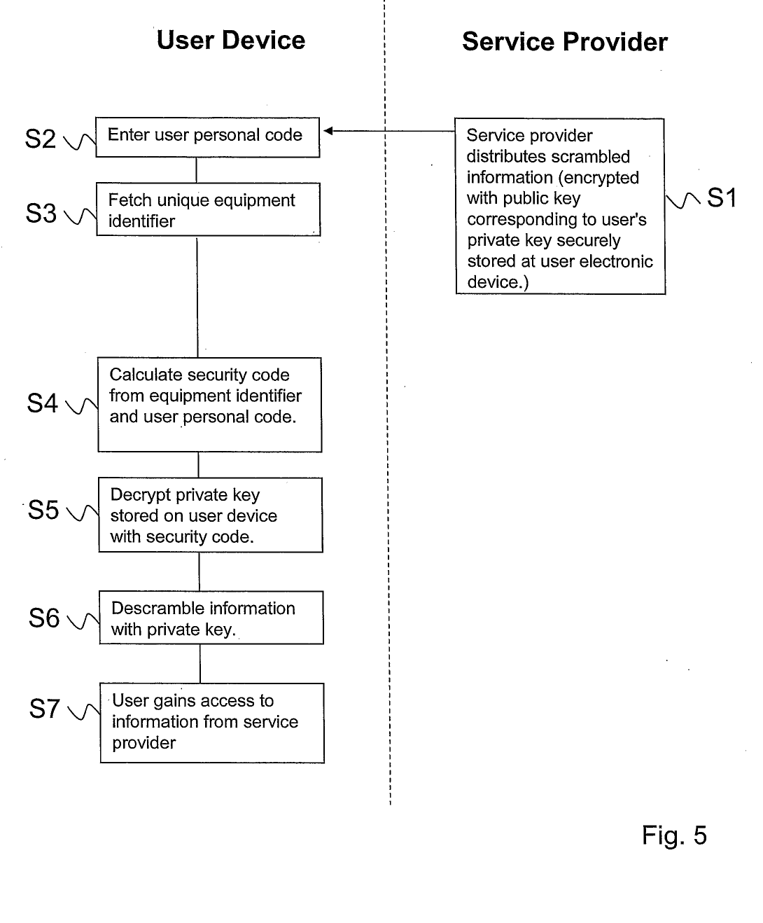

In such a case, if the service provider wishes to use an asymmetric, dual key crypto scheme, whereby information to be distributed to users is to be encrypted prior to transmission to a user, the information may, as illustrated in FIG. 5, be scrambled prior to transmittal by using a public key of the crypto scheme (step S1). Provided arrangements are made for the corresponding private key of the crypto system to be stored in advance on the user device in an encrypted format obtained by the use of the security code as encryption key, then, upon the receipt of the scrambled information, the user device may be programmed to:
decrypt the encrypted private key stored on the device by using the security code as decryption key (step S5), and to
descramble the scrambled information received from the service provider by using the decrypted private key (step S6).

In this case, the security code need not be stored at the site of the service provider. The public key may be specified by the user or be stored in advance at the site of the service provider, or be publicly available through a notice/bulletin board service.

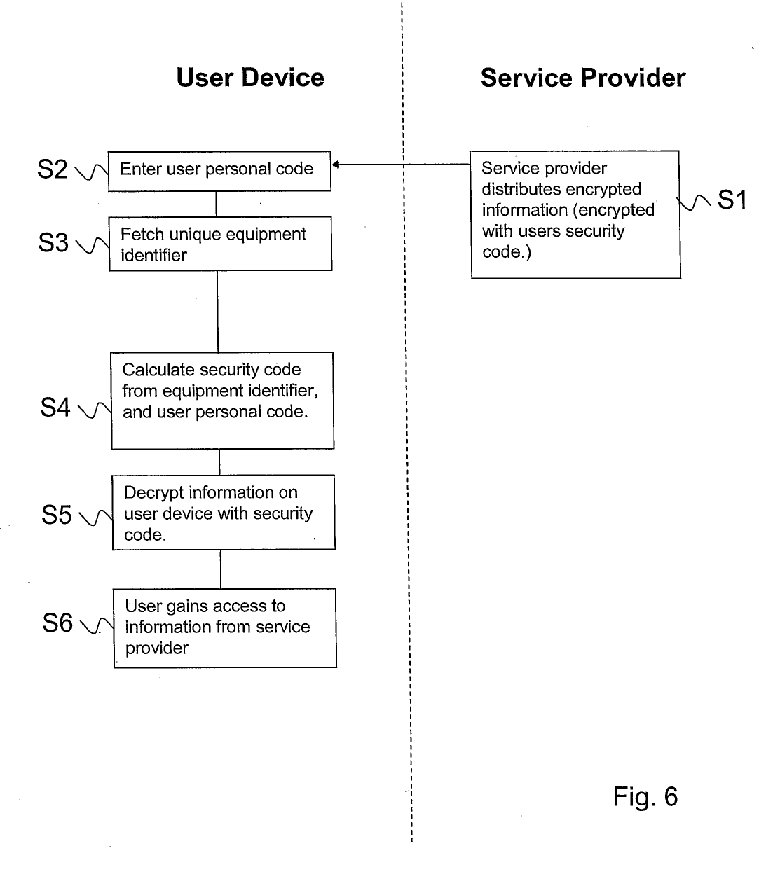

Alternatively, in stead of using a dual key crypto scheme, the service provider may use the security code of the invention in connection with the distribution of secret information, provided arrangements are made for storage at the site of the service provider, of the security codes of the users of the provider's services. Such a process, whereby the information is encrypted prior to transmittal by using the security code as encryption key (step S1 in FIG. 6), may, as illustrated in FIG. 6, comprise steps, whereby the encrypted information received from the service provider is decrypted by using the just calculated security code of the device (steps S4 and S5 in FIG. 6).

In both cases, after being used, the decrypted information is preferably deleted for security reasons, leaving no trace thereof on the device (unless it is stored locally by using the security code as local encryption key, as illustrated in FIG. 3).

### The Security Code Used for Authentication

In addition the security code may, in deed, be used as a basis for the verification of the identity of the user and the user device belonging to him/her.

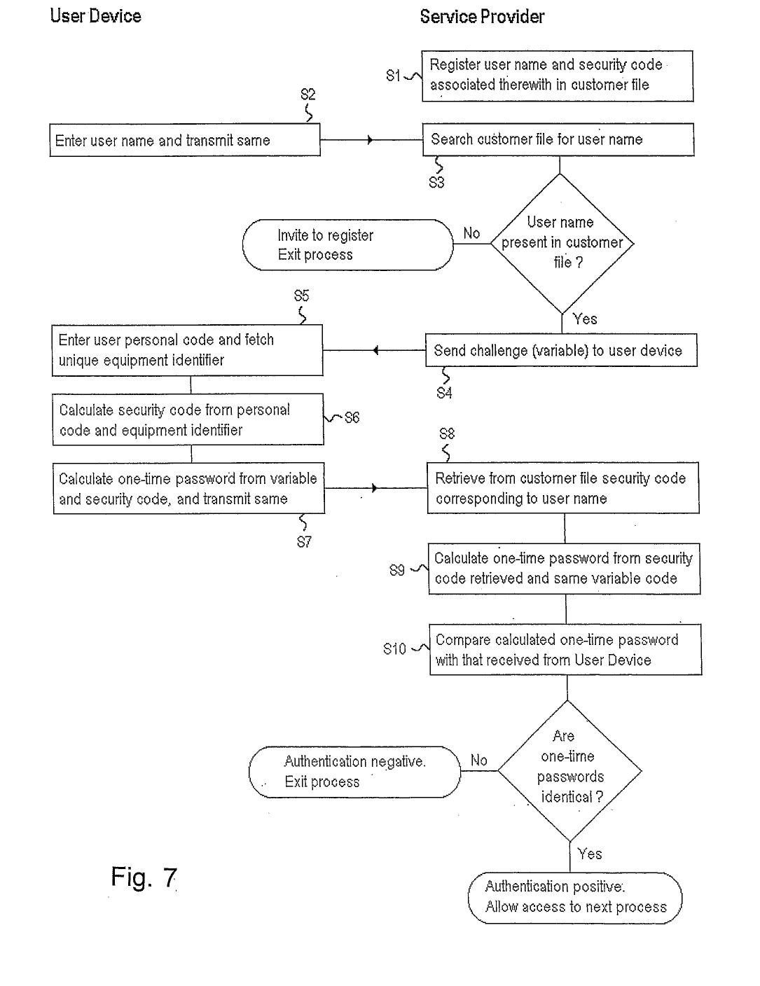

In one embodiment of the invention the user device comprises a communications module 6 (see FIG. 1). In the context of the authentication method according the invention the communications functionality thus provided may be used for exchanging information, preferably “on-line”, with service providers via the user device itself. In such a case, referring to FIG. 7, given that the user is already registered in a customer file at a service provider with his/her user name and an associated security code according to the invention, the method of authenticating a user of the user device, may comprise the following steps:
entering into the electronic device a user name and transmitting from the device to the service provider the user name entered (step S2),
at the service provider searching in the customer file to find the user name received from the electronic device, and if present in the file, transmitting from the service provider a challenge to the electronic device (steps S3 and S4),
entering into the electronic device a user personal code and fetching from the data storage means of the electronic device the equipment identifier of the device (step S5),
calculating internal to the electronic device a security code based on said equipment identifier and said user personal code (step S6),
by using a cryptographic algorithm calculating internal to the electronic device a one-time password based on said security code and a variable received from the service provider as part of said challenge (step S7),
transmitting from the electronic device to the service provider the calculated one-time password (step S7),
at the service provider retrieving from the customer file the security code corresponding to the user name received from the electronic device (step S8),
by using the same cryptographic algorithm as the user device calculating at the service provider a one-time password based on the security code retrieved from the customer file and the same variable as that conveyed to and used by the electronic device (step S9), and
at the service provider comparing the one-time password just calculated with that received from the electronic device (step S10).

If the one-time passwords are identical, the authentication result is positive, confirming that the user identified by user name is in possession of the electronic device and of a corresponding user personal code, otherwise, the authentication result is negative.

When the user device is equipped with a communications module, the present invention may also be used for message authentication by calculating a digital signature or MAC (Message Authentication Code) from a message, or from a digest thereof, to be communicated between the user device and a service provider, or other third party, the security code according to the invention being one of the components taking part in that calculation.

In another embodiment of the invention, where the user device does not include a communications module and, hence, no direct exchange of information with service providers via the user device itself is possible, or if it is not convenient to exchange all information through the device, the user may act as an “intermediary” between the user device and service provider. To communicate with the service provider the user may then use any communications means available, such as a personal computer connectable to the Internet, for example, the main issue being that the exchange of the user's indications to the service provider and the responses returned by the service provider to the user is accomplished in an acceptable manner, preferably in real time. The communication link or channel itself may, if required for security reasons, of course be scrambled or encrypted in any conventional way.

In principle, whether there is a technical arrangement for equipment-to-equipment communications present, or not, the authentication method of the invention may be similar to that illustrated in FIG. 7, only with a person and some other communications arrangement as “intermediary” when the user device lacks the communication functionality.

The possibility is also envisaged, in stead of having a variable received from the service provider as part of a challenge therefrom (step S7 in FIG. 7), a variable to be used for the calculation internal to the user device, of the one-time password may be generated by the user device itself. In such a case, arrangements must be made by which the service provider is enable to use the same variable in the calculation at that side, of a one-time password (step S9 in FIG. 7) for comparison with that from the user device (step S10 in FIG. 7). Such arrangements are known to people skilled in the art and may comprise mechanisms using synchronized parts of a time-variable or sequence number, for example.

### Initial User Registration

For many services offered to the public, generally the customer or user of such a service must register with the respective service provider to get access to the service(s) concerned (e.g. subscribe to the service). In the context of utilizing embodiments of the present invention for such services, this is also the case. Hence, as illustrated by step S1 in FIG. 7, for example, it is a prerequisite that the user initially is registered at the service provider with his/her user name and an associated security code obtained by a method of the invention.

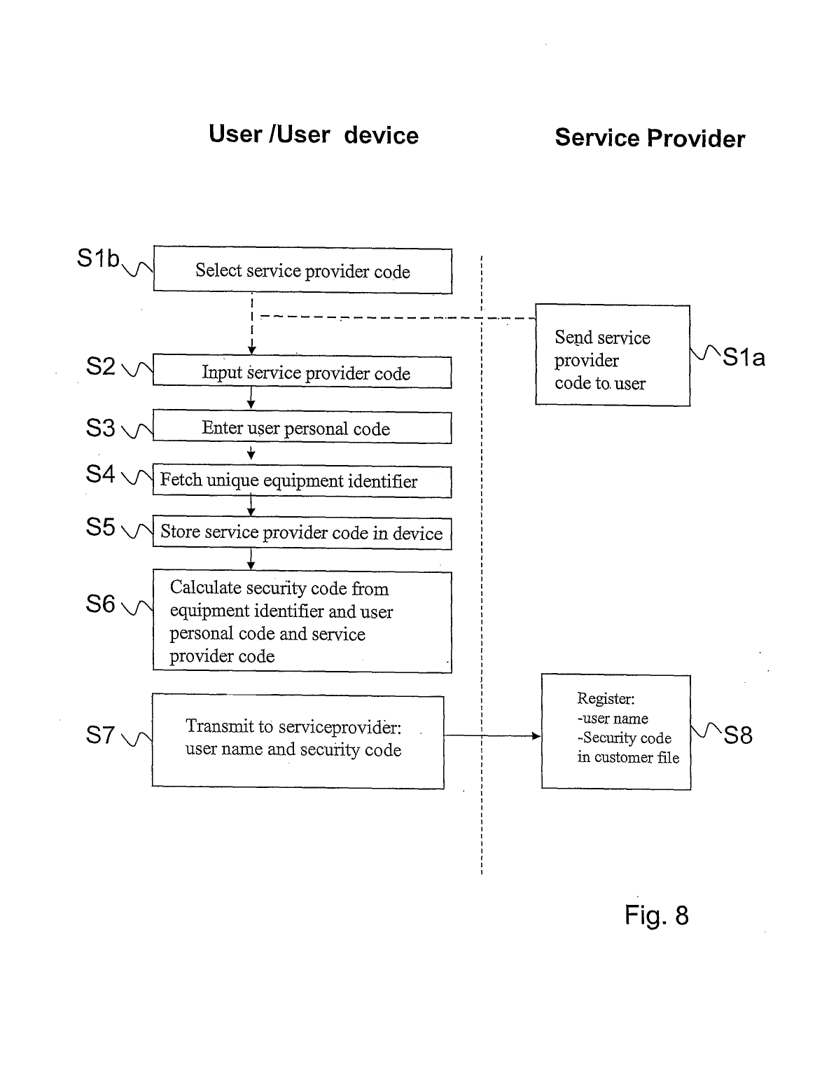

One way for the user to obtain his/her security code is to carry out the steps of the method explained above in the section “Security Code Calculation” and illustrated in FIG. 2, producing a “two-factor code”. Another way is first to input a specific service provider code (which may relate to one specific service only) and then calculate a “three-factor code”, also mentioned in said section. Such a procedure may, as illustrated in FIG. 8, comprise the following steps:
from the service provider sending a service provider code to a user (step S1a), or leave it to the user to select a service provider code (step S1b),
at the user's site inputting the service provider code to the user device (step S2),
entering into the electronic device, typically by means of the keyboard, the user personal code (step S3),
fetching from the data storage means of the electronic device the equipment identifier of the device (step S4),
optionally storing the service provider code in the data storage means of the electronic device (step 5),
calculating internal to the electronic device a security code based on the equipment identifier, user personal code and service provider code (step S6),
sending to the service provider the user name and calculated security code (step S7), and
registering in a customer file at the service provider the user name and associated security code received from the user (step S8).

In either case the exchange of information between user and service provider may be accomplished by any communications means available, such as by means of letters through the postal service, facsimile, or even through voice communication.

Although the present description of preferred embodiments is made on the basis of the invention being implemented in software, the invention may be realised by means of hardware components performing similar tasks as the software of the embodiments described.

1. A method of producing a reproducable security code for user authentication, and for storing, signing and encryption/decryption of information by means of a programmable user device comprising at least one data input interface, data processing means and data storage means including a readable tamper-proof storage in which an equipment identifier uniquely identifying the user device is prestored, the method being characterized in that it comprises the steps of:
inputting via said data input interface a user personal code into the user device,
fetching the equipment identifier from the data storage means of the user device,
calculating internal to the user device a security code based on a combination of at least said equipment identifier and said user personal code, and
outputting the calculated security code, the security code thus calculated in itself representing both the user and the user device.

2. A method according to claim 1, further comprising the steps of, prior to the calculation internal to the user device of a security code:
inputting to the user device a service provider code representing a service provider by whom the user is registered with his/her user name,
calculating internal to the user device a security code based on a combination of the equipment identifier, the user personal code and said service provider code, and
outputting the calculated security code, the thus calculated security code in itself representing the user and the user device to one specific service provider.

3. A method according to claim 1, wherein the user personal code and the service provider code each comprises a respective sequence of alphabetic and/or numeric characters, or a sequence of binary data.

4. A method according to claim 1, wherein biometric data representative of the user of the device makes up all or part of the user personal code.

5. A method according to claim 3, wherein the service provider code represents a service offered by the service provider.

6. A method according to claim 2, further comprising the step of storing the service provider code in the data storage means of the user device.

7. A method according to claim 6, wherein the calculation internal to the user device of a security code being based on a combination of the equipment identifier, the user personal code and said service provider code previously being stored in the data storage means of the user device.

8. A method of authenticating the user of a user device, the user being registered in a customer file at a service provider with his/her user name and an associated security code obtained by a method according to claim 1, the method being characterized in that it comprises the steps of:
indicating a user name to the service provider,
at the service provider searching in the customer file to find the user name indicated, and if present in the file, returning a challenge to the user,
inputting to the user device a user personal code and fetching from the data storage means of the user device the equipment identifier of the user device,
calculating internal to the user device said security code,
inputting to the user device a variable received from the service provider as said challenge and by using a cryptographic algorithm calculating internal to the user device a one-time password based on said security code and said variable,
indicating the calculated one-time password to the service provider,
at the service provider retrieving from the customer file the security code corresponding to the user name indicated by the user,
by using the same cryptographic algorithm as the user device calculating at the service provider a one-time password based on the security code retrieved from the customer file and the same variable as that returned to the user and used by the user device,
at the service provider comparing the one-time password just calculated with that received from the user, and if the one-time passwords are identical, the authentication result is positive, confirming that the user identified by user name is in possession of the user device and of a corresponding user personal code, otherwise, the authentication result is negative.

9. A method according to claim 8, wherein the indications given by the user to the service provider and the responses returned by the service provider to the user are conveyed by means of a communications arrangement allowing exchange of information between the user and the service provider.

10. A method according to claim 9, wherein the user device is provided with a communications functionality allowing the user to enter his/her indications to the service provider through a data input interface of the device for transmittal to the service provider and to receive the responses from the service provider directly into the user device.

11. A method according to claim 9, wherein the two-way communications arrangement comprises a public communications service or facility which is available to the user external to the user device.

12. A method of securely storing information on a programmable user device comprising at least one data input interface, data processing means and data storage means including a readable tamper-proof storage in which an equipment identifier uniquely identifying the user device is prestored, the method comprising the steps of encrypting the information prior to storage and decrypting the information upon retrieval of the stored, encrypted information, the method being characterized in that:
the step of encrypting the information comprises encrypting the information to be stored by using a security code as encryption key, and
the step of decrypting the information comprises retrieving the stored, encrypted information by using the same security code as decryption key, said security code being produced by the steps of:
inputting via said data input interface a user personal code into the user device,
fetching the equipment identifier from the data storage means of the user device,
calculating internal to the user device a security code based on a combination of at least said equipment identifier and said user personal code, and
outputting the calculated security code for the encryption/decryption steps, respectively.

13. A method according to claim 12, wherein biometric data representative of the user of the device makes up all or part of the user personal code.

14. A method of signing an information element to be exchanged between the user of a user device and a service provider, the user being registered in a customer file at the service provider with his/her user name and an associated security code obtained by a method according to claim 1, the method being characterized in that it comprises the steps of:
transferring from the service provider to the user device the information element to be signed by the user, if the information element is not present at the user device,
inputting to the user device a user personal code and fetching from the data storage means of the user device the equipment identifier of the user device,
calculating internal to the user device said security code,
by using a cryptographic algorithm, calculating internal to the user device a “signature” based on said security code and the information element to be signed and transferred to the service provider,
transferring the user name and the “signature” to the service provider, and if the information element to be signed by the user is not present at the service provider, also transferring the information element to the service provider,
at the service provider retrieving from the customer file the security code corresponding to the user name received from the user,
by using the same cryptographic algorithm as the user device, calculating at the service provider a “signature” based on the security code retrieved from the customer file and the information element,
at the service provider comparing the “signature” just calculated with that received from the user, and if the “signatures” are identical, confirming that the user on the user device has intentionally signed the information element and that the information element has not been modified, otherwise, the signing result is negative.

15. A method of signing an information element according to claim 14, wherein the “signature” comprises a digital or electronic signature, or a message authentication code (MAC).

16. A method of securing an information element to be transferred from the user of a user device to a service provider, the user being registered in a customer file at a service provider with his/her user name and an associated security code obtained by a method according to claim 1, the method being characterized in that it comprises the steps of:
inputting to the user device a user personal code and fetching from the data storage means of the user device the equipment identifier of the user device,
calculating internal to the user device said security code,
by using a cryptographic algorithm and said security code as encryption key, encrypting internal to the user device the information element to be transferred to the service provider,
transferring the user name and the encrypted information element to the service provider,
at the service provider retrieving from the customer file the security code corresponding to the user name received from the user, and
by using the same cryptographic algorithm as the user device, decrypting at the service provider the encrypted information element using the security code retrieved from the customer file as decryption key.

17. A method of securing an information element to be transferred from a service provider to the user of a user device, the user being registered in a customer file at a service provider with his/her user name and an associated security code obtained by a method according to claim 1, the method being characterized in that it comprises the steps of:
at the service provider retrieving from the customer file the security code of the user to whom the information element is to be transferred,
by using a cryptographic algorithm and said security code as encryption key, encrypting said information element,
transferring the encrypted information element to the user,
upon receipt in the user device of said encrypted information element, inputting to the user device a user personal code and fetching from the data storage means of the user device the equipment identifier of the user device,
calculating internal to the user device said security code, and
by using the same cryptographic algorithm as the service provider, decrypting in the user device the encrypted information element using the security code just calculated as decryption key.

18. A programmable user device comprising at least one data input interface, data processing means, data storage means including a readable tamper-proof storage in which an equipment identifier uniquely identifying the user device is prestored, the user device being characterized in that it is programmed to run a process according to the method of claim 1.

19. A user device according to claim 18, the equipment identifier of which being a product serial number embedded in the device prior to delivery to a user.

20. A user device according to claim 19, the device being a mobile telephone (cell phone), the equipment identifier of which being an international mobile equipment identity (the IMEI code in the case of a GSM phone).
